(19) United States
(12) Patent Application Publication
(10) Pub. No.: US 2022/0314678 A1
(43) Pub. Date: Oct. 6, 2022

(54) LINERLESS LABELS

(71) Applicant: ILLINOIS TOOL WORKS INC., Glenview, IL (US)

(72) Inventor: Kevin Roy CARTWRIGHT, West Midlands (GB)

(21) Appl. No.: 17/620,266

(22) PCT Filed: May 18, 2020
(86) PCT No.: PCT/US2020/033362

§ 371 Date: Dec. 17, 2021

(30) Foreign Application Priority Data
Jun. 20, 2019 (EP) 19181546.3

(51) Int. Cl. B41M 5/42; B41M 5/30; B41M 5/323

(52) U.S. Cl. CPC B41M 5/42; B41M 5/30; B41M 5/323; B41M 2205/04; B41M 2205/38; B41M 2205/40

(57) ABSTRACT

A linerless thermal sheet arranged as a roll, includes a substrate having a first face and a second face, whereby the first face opposes the second face; an adhesive layer on at least part of the first face of the substrate; a thermosensitive layer on at least part of the second face of the substrate, the thermosensitive layer including a first portion and a second portion whereby the first portion and the second portion do not overlap; a release coating applied onto the thermosensitive layer, the release coating has a low adherence to the adhesive layer; at least one colour image is deposited on the first portion of the thermosensitive layer such that the at least one colour image is between the thermosensitive layer and the release coating, whereby the second portion of the thermosensitive paper is blank for thermally-printed information.

### FIELD OF THE INVENTION

The present invention relates to thermosensitive adhesive labels, more specifically, in the field of linerless thermosensitive labels.

### BACKGROUND

Adhesive labels can be used for a variety of purposes, for example, they are attached to commercial products for indicating their names, contents, pricing, branding, etc., or to postal matters for indicating their destination/return address. These are conventionally written by stamping ink, however, the stamping method has the disadvantage of requiring refilling of ink.

One way of overcoming this disadvantage taught in U.S. Pat. No. 4,851,383 (John Fickenscher) is by application of thermosensitive recording to such adhesive labels. Thermosensitive labels typically comprise a substrate, a colour-forming layer disposed on one side of said substrate with a barrier layer disposed over the colour-forming layer and on an opposite side of the substrate to prevent discolouration of the colour-forming layer and/or fading of heat-formed printing in the colour-forming layer. A pressure sensitive adhesive is disposed over the barrier layer on the opposite side of the label, and a backing paper is disposed thereon to protect the adhesive until the label is used. The backing paper commonly comprises a releasing agent, e.g. silicone, to facilitate removal of the backing sheet from the label when the label is to be applied onto packaged goods, postal packages, etc. Typically, for these type of thermosensitive, pressure sensitive labels, the label and backing paper are manufactured in a long continuous strip which is rolled for storage and handling purposes.

Typically, the label strip is adapted depending on the requirements of the purchaser of the continuous strip of labels. The adapting of the label strip typically includes printing of text and/or images and die-cutting the label into individual desired shapes (whereby the die penetrates and cuts only the label material, not the backing sheet). The uncut backing sheet can then be used to support the die-cut labels.

These die-cut labels have the disadvantage of bulk; the backing sheet represents approximately one half of the total thickness and mass of the final label as stored. Therefore, eliminating the backing sheet is desirable, as this would effectively double the number of usable labels for a given size of roll of labels. The elimination of backing paper, which results in a reduction in weight and volume per usable label, would also reduce costs such as the transportation, handling and storage costs, as well as significantly reduce the environmental cost by eliminating the potential waste product. The purchaser of the labels, e.g. postal services, a retailer or manufacturer of goods, would typically imprint the labels with information pertaining to a product that they are to be attached to, and when ready to be applied the purchaser/user will peel the label from the backing sheet and adhere said label to the product. The waste product here is the backing paper. Therefore, these die-cut labels on backing paper represent a very large environmental problem as approximately 50% of the label roll is to be separately discarded.

For this reason, “linerless” or “liner-free” labels were introduced whereby adhesive labels could be arranged in a roll without necessitating backing paper. Such labels are disclosed in U.S. Pat. No. 4,851,383; this discloses linerless labels with a thermosensitive layer with dye for forming colour imagines, and a silicone release coating. The thermosensitive layer and the silicone release coating are separated by a barrier layer. U.S. Pat. No. 5,292,713 discloses thermosensitive linerless labels that overcome some of the problems of U.S. Pat. No. 4,841,383; it does this by simplifying the construction—disclosed are thermosensitive linerless labels containing a pressure sensitive adhesive covering one face of a substrate having a thermosensitive layer on the opposite face, and a release coating applied directly to the thermosensitive layer. U.S. Pat. No. 5,508,247 discloses a linerless direct thermal-printed label, as opposed to the thermal transfer-printed labels of U.S. Pat. No. 4,841,383. Direct thermal printing requires the print head elements to be in direct contact with the label material as it is pulled across the print head whereas thermal transfer printing has a thermal ribbon acting as a buffer between the print head elements and the label material. As thermal ribbon uses a poly-based carrier made from crude oil products, eliminating the use of thermal transfer ribbon can therefore positively impact a company's goal for a reduced carbon footprint. Direct thermal technology eliminates the use of thermal ribbons and therefore the waste created through its use. Thermal transfer, however, typically provides longer-lasting and higher quality printing. Rolls of linerless labels, unlike backing paper-lined labels, can either be cut automatically by printing equipment or comprise a line of weakness (e.g. a perforation) between separate labels such that each label can be separated. In the case of the print length being automatically adjusted so there is minimal unused space on the label, this prevents unnecessary label consumption.

It is also common for linerless labels, e.g. in U.S. Pat. No. 4,851,383 to comprise a barrier layer between the silicone release layer and the thermosensitive layer, this increases the overall thickness of the linerless label and increases the production costs. EP 0 579 430 A1 describes a linerless paper that benefits from applying the release coating directly onto the thermosensitive layer rather than requiring a barrier layer. It does this by applying a release coating directly to the thermosensitive layer, the release coating having non-stick or low adhesion characteristics with respect to the pressure sensitive adhesive. One particularly suitable release coating contains as the primary operative ingredient chromium pentahydroxy (tetradecanoato) di-. This is available commercially under the trade name “QUILON C”. The coating is preferably prepared by application then drying of a formulation containing between about 5-25 parts QUILON C, and about 75-95 parts water or alcohol. Alternatively, the release coating may comprise a UV curable silicone, such as that available commercially from General Electric under the designation “G.E. 9300” and containing about 1-3% by weight photoinitiator (e.g. UV 9365C-D1).

Linerless labels have several advantages over standard backing-paper labels, these include more labels per roll, no liner waste removes the risk of injury through slippage, less waste disposal translator to less carbon emission, reduced transportation costs, supports a lower carbon footprint and less storage space is required.

U.S. Pat. No. 6,585,437B1 discloses a linerless label with indicators (“Black marks”) which are machine-readable markings on the label so that a cutter/printer with a detector can precisely cut the label roll into integers. However, a problem with this is that even after cutting, the black marks are still visible (on either the front and/or reverse of the label) which is aesthetically undesirable for commercial use. EP3457388A1 addresses this problem by applying optical brighteners in the label (either in the adhesive layer or overlaying the thermo-reactive paper) such that, under normal lighting conditions, they are not visible to the naked eye but are still machine-detectable by a printer/cutter under UV light. Additionally, EP3457388A1 discloses the addition of a colour coat between the thermo-reactive paper and the silicone layer of the linerless label.

One common problem with labels, especially those with colour, is unreadable barcodes and/or QR codes (and/or other machine-readable representations of data) that have been thermally printed on the label. This can be due to one of or a combination of low contrast, improper reading position and/or distortion. There is a need for a linerless label paper which comprises colour without the colour causing any detriment to the thermally printed information.

### SUMMARY OF THE INVENTION

The present invention addresses the above problem by providing a linerless thermal sheet arranged as a roll, comprising a substrate having a first face and second face; an adhesive layer on at least part of said first face of said substrate; a thermosensitive layer on at least part of said second face of said substrate, said thermosensitive layer comprising a first portion and a second portion whereby the first portion and the second portion do not overlap; a release coating applied onto the thermosensitive layer, said release coating has a low adherence to said adhesive layer; at least one colour image is deposited on the first portion of the thermosensitive layer so as to provide a blank window for thermally printed information in the second portion of the thermosensitive layer, whereby the at least one colour image is between the thermosensitive layer and the release coating. Preferably, the thermally printed information is a barcode or a QR code.

For the purpose of the present invention, the term “blank window” means in absence or devoid of any image or indicia or text so as to accommodate a barcode or QR code in the second portion of the thermosensitive paper. By providing the thermosensitive layer of the thermal sensitive sheet with juxtaposed first and second portions, whereby the second portion comprises a blank for thermally-printed information, the blank can be employed to provide information without the thermally printed information being distorted due to low contrast or interference from a background image (which is only possible where the first portion comprising the at least one colour image overlaps the second blank portion). For example, printing a bar code or QR code on a colour background image has the tendency to distort the information carried by the barcode or QR code resulting in the barcode or QR reader not being able to decode all of the information carried by the barcode or QR code. In some cases, several attempts are necessary to scan the barcode or QR code across the reader before the reader can decode all of the information carried by the barcode or QR code. In a busy supermarket or hypermarket, where goods are scanned across a sensor/reader at a rapid rate such misread codes can delay processing of the goods and in an extreme cases, leading to the goods to not being properly recorded at the supermarket purchase till. For example, the at least one colour image may have a graduated tint such that, at some point of the linerless thermal sheet, the graduated tint background and the thermally printed foreground overlap resulting in information that is not processable by a human eye or by machine/detector because of a lack of contrast, e.g. black thermally-printed information overlaying a black or dark-coloured image. Therefore, by providing thermally-printed information only on the blank second portion of the thermosensitive paper, the information is over a consistent background (usually white or neutral in colour) such that it is easy to read by eye and/or by a machine/detector.

By the thermosensitive layer having a first and second portion for the at least one colour image and the blank, respectively, the blank provides an area on the thermosensitive sheet for information to be thermally printed such that there is sufficiently high contrast between the information and the blank and, consequently, making the thermally-printed information readable by eye and/or by machine/detector.

The linerless thermal sheet may further comprise a machine-readable demarcation indicating a tear/cut line. The demarcation is indicative of the length of individual labels of the linerless thermal sheet. The machine-readable demarcation may be any one of a cut-out notch, a perforation, the at least one colour image mark and/or the thermally-printed information.

The length of an individual label from the linerless thermal sheet arranged as a roll may be fixed or it may be variable. The at least one colour image is deposited on at least one margin of the thermosensitive layer. For example, the at least one colour image is deposited on the thermosensitive layer to form a banner running along the length of the linerless thermal sheet. In some cases, the at least one colour coat may comprise a reoccurring pattern, whereby the reoccurring pattern may have a different length to the length of an individual label.

The at least one colour image may be deposited onto the thermosensitive layer by any method known in the art, e.g. roller printing, inkjet printing and/or digital printing.

In another aspect of the present invention, a method of manufacturing a linerless thermal sheet arranged as a roll comprises the steps of (i) depositing a colour image to a first portion of a thermosensitive layer on a first face of a substrate that is arranged to provide a blank second portion of the thermosensitive layer on the first face; (ii) applying a coating on the thermosensitive layer on the first face of the substrate so as to sandwich the colour image between the thermosensitive layer and said coating; and (iii) applying an adhesive to a second face of the substrate, whereby the second face of the substrate opposes the first face of the substrate. The method may further comprise the step of providing at least one machine-readable demarcation to indicate a cut/tear line, said machine-readable demarcation being at least one of a cut-out, rear-printed black marks.

### BRIEF DESCRIPTION OF THE DRAWINGS

Further preferred features and aspects of the present invention will be apparent from the claims and the following illustrative description made with reference to the accompanying drawings in which:

FIG. 1 is a schematic representation of a cross section of the linerless thermal sheet showing the various layers;

FIG. 2 is a schematic representation of a plan view of the linerless thermal sheet, with thermally printed information thereon;

FIG. 3 is a schematic representation of a roll of the linerless thermal sheet showing the arrangement of the colour images along the margins and the demarcation lines;

FIG. 4 is a schematic representation of an exemplary apparatus for manufacturing the linerless thermal roll according to an embodiment of the present invention.

### DETAILED DESCRIPTION

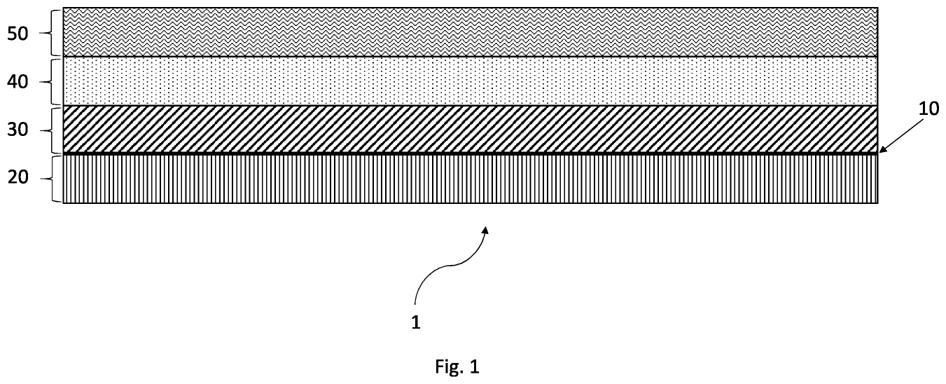

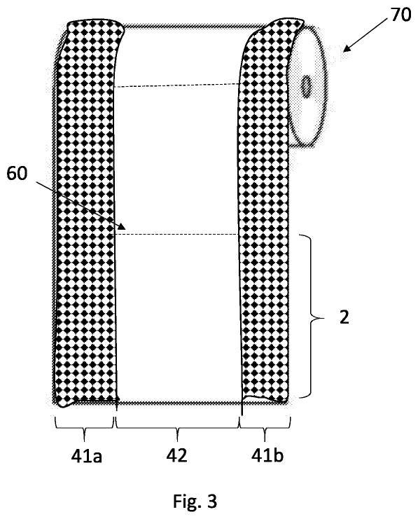

According to the present invention, and as illustrated in FIG. 1, a linerless thermal sheet 1 comprises a substrate 10 (shown as a thick horizontal line through the label) with a first and second side (whereby/wherein the first and second side are on opposing faces of the substrate), an adhesive layer 20 on the first side, a thermosensitive layer 30 on the second side, a coating 50 applied onto the thermosensitive layer, wherein the coating comprises a release coating that does not adhere (or has low adherence) to the adhesive layer 20 such that if the label is arranged in a stack or in a roll 70 (see FIG. 3), each sheet 1 can be removed from the stack or roll with minimal effect on adhesive layer's 20 ability to subsequently adhere to a surface other than the coating 50. The substrate 10 can be any suitable paper or plastic known in the art and the thermosensitive layer 30 can be any suitable conventional thermal or thermal transfer material known in the art. The adhesive layer 20 is a pressure sensitive adhesive (PSA). The PSA can be any conventional PSA known in the art and can be either a permanent PSA or a repositionable PSA. The release coating may be any type of release coating known in the art that has between zero to low-adherence to the adhesive layer 20. In some options, the release coating comprises silicone and can be a UV curable silicone. Typically, a barrier layer is applied to the thermosensitive layer prior to application of the release coating in order to prevent material composed of the release layer soaking into the thermosensitive layer and/or the substrate paper. In the embodiment shown in FIG. 1, the coating 50 comprising the release coating is shown as a single coating 50 that is applied directly onto the thermosensitive layer. The single coating 50 can be based on the release coating taught in the EP 0579430 (Moore Business Forms, Inc). However, the linerless thermal sheet of the present invention is not only restricted to having a single release coating 50 deposited on the thermosensitive layer but can also include a separate barrier layer.

The linerless thermal label 1 further comprises at least one colour image 40 sandwiched or disposed between the thermosensitive layer 30 and the coating 50 such that information and/or symbol(s) can be made visible on the linerless thermal sheet 1 without the need for thermal printing.

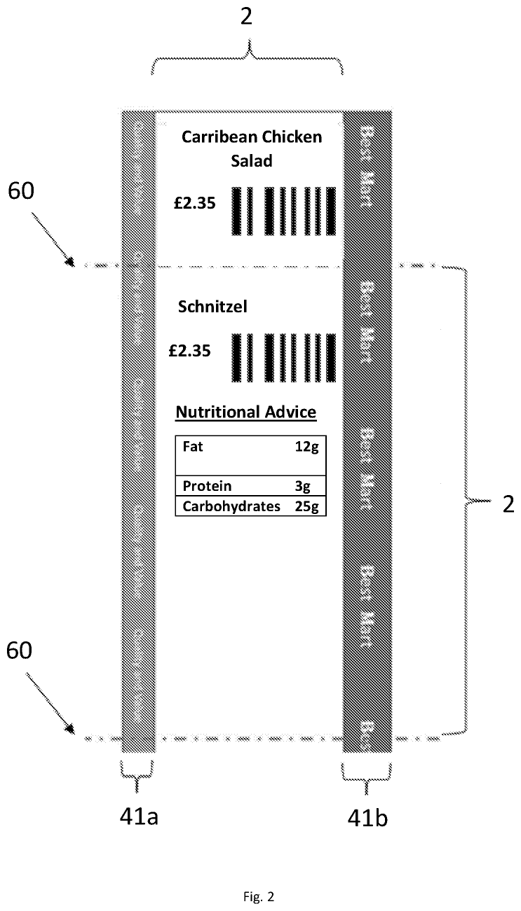

Now referring to FIG. 2, the at least one colour image is deposited on a first portion 41 of the thermosensitive layer such that a second portion 42 of the thermosensitive layer 30 is “blank” for thermally-printable information, such as that shown in FIG. 2, to be applied thereon. Either one or both of the first or second portion may comprise one or more distinct area(s) on the thermosensitive layer. In the particular embodiment shown in FIG. 2, the at least one colour image is deposited on at least one margin of the thermosensitive layer. For example, as shown in FIG. 2, the colour image is deposited on both left and right margins of the thermosensitive layer 30 such that the first portion 41 comprises two distinct areas (printed as a green banner 41a and a blue banner 41b) separated by a blank portion representing the second portion 42 therebetween (shown with a white background). The blank portion 42 provides an area for thermally printing information, e.g. text, e.g. pricing information and machine readable codes such as QR or barcodes. For example, when formed as a roll 70 as shown in FIG. 3, the colour images extend in a repetitive pattern along both the left 41a and the right 41b margins of the linerless thermal sheet. When fed through a thermal printer, information about a product such as pricing information and a machine readable code (e.g. barcode or QR code) is thermally printed in the blank regions between the colour margins as shown in the example of a printed label shown in FIG. 2.

The linerless thermal sheet may further comprise a machine-readable demarcation 60 to separate the linerless sheet into individual discrete labels. The machine readable demarcation 60 is capable of indicating the start and/or end of an individual label 2. The machine-readable demarcation 60 may be used by a printer or a label cutter to precisely cut the label to a predetermined size (depending on the position of the demarcation(s)).

The thermosensitive layer 30 may comprise any suitable colour forming system, such as a leuco dye or a metallic dye system. Optionally, or additionally, the thermosensitive layer may comprise optical brighteners. Optical brighteners (which also encompasses optical brightening agents, fluorescent brightening agents, and/or fluorescent whitening agents) are materials that absorb UV light and re-emit blue light by fluorescence. These materials, in the thermosensitive layer, cause a “whitening effect” which increases the contrast between the background and the thermally-printed information (which is typically black or dark).

The coating 50, which acts as a barrier between the thermosensitive layer 30 and the adhesive layer 20 (described below) when the thermal sheet 1 is formed as a roll, may be applied as a complete coating so as to completely cover the surface of the thermosensitive layer, or in a spot/patterned configuration. The coating 50 may be configured to lie in proximity to the adhesive layer 20 when the linerless thermal sheet is configured as a wound roll, so as to facilitate unrolling of the linerless thermal sheet without the adhesive bonding the first side of the substrate 10 to the second side of the substrate 10.

The adhesive layer 20 on the first side of the substrate 10 may be a full covering or arranged as a spotted/patterned covering. The adhesive layer 20 may be deposited onto the first side of the substrate 10 by any conventional method.

The at least one colour image 40 on a first portion 41 of the thermosensitive layer 30 may be deposited using any known methods of ink printing. The at least one colour image 40 may be in the form of a banner or banners, i.e. vertical stripe(s) as shown in FIG. 2. The at least one colour image is contrasted with a second portion 42 formed as the blank for being activated by feeding the linerless thermal sheet 1 through a thermal (e.g. direct thermal) printer. It is the juxtaposition of the at least one colour image on the first portion 41 and the blank on the second portion 42 that provides sufficient contrast between the two portions so as to clearly differentiate between them, and so as to provide a window for thermally-printed information on the “blank” second portion 42.

In some options, the at least one colour image 40 on a first portion 41 of the thermosensitive layer 30 may form a frame around blank second portion 42.

The separation of the first portion 41 and second portion 42 are so because overlaying thermally printed information over a first portion risks a lack of contrast between the thermally printed information and the at least one colour image 40, therefore making it difficult for the human eye or machine to detect the thermally printed information. For example, a machine-readable code, such as a barcode, requires sufficient contrast between the bars and the background. If the barcode is thermally printed onto the first portion 41, and the at least one colour image comprises at least one colour that is the same or similar shade to the thermally printed barcode, then the barcode may not be machine-readable or at least not effectively machine readable, leading to an unusable label. Therefore, the thermally printed information is only printed on the second portion 42 which does not overlap with the first portion 41, and remains blank such that the thermally printed information has sufficiently high contrast and can be read with ease by a human eye and by a sensor.

The linerless thermal sheet 1, which comprises the substrate 10, the thermosensitive layer 30, the adhesive layer 20, the release coating 50, the at least one colour image 40 on a first portion of the thermosensitive layer 30, and the blank of the second portion 42 of the thermosensitive layer, may be rolled to form a roll as shown in FIG. 3 having demarcations representing separate discrete labels 2 with the adhesive layer 20 in contact with the coating 50.

Typically, a thermal printer (e.g. direct thermal printer) used for activating the linerless thermal sheet 1 comprises a cutter to cut the sheet at a location based on a provided signal by a sensor, whereby the sensor is for sensing at least one of presence, absence or demarcations.

In the cases where the roll comprises separated labels, each with a fixed and predetermined length in said roll, the linerless thermal sheet 1 may comprise demarcations in the form of cut-outs. These cut-outs can be in the form of semi-circles or rectangular cut-outs along either or both of the long edges of the thermal sheet 1.

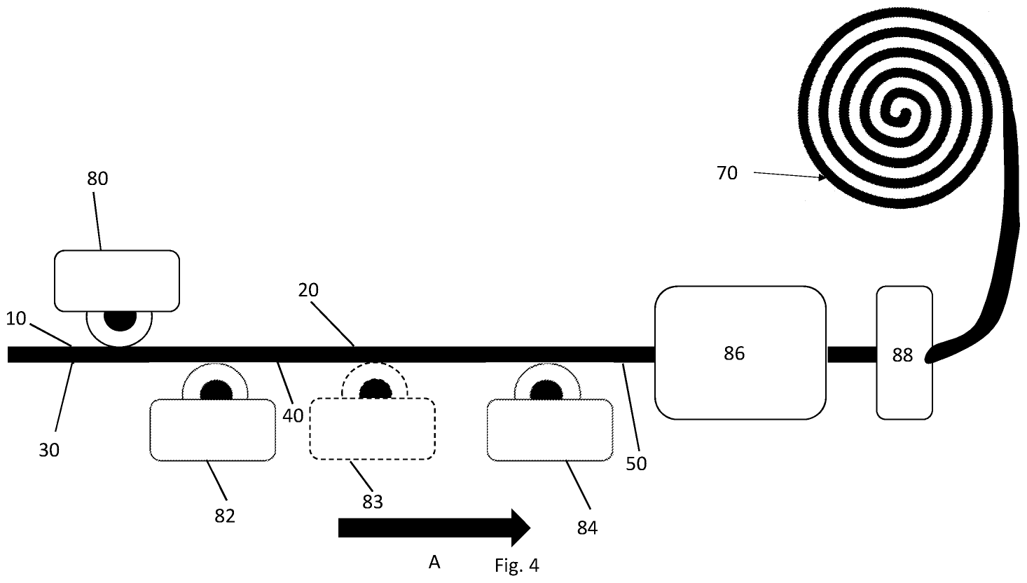

FIG. 4 shows a schematic view illustrating an exemplary process in the production of the linerless thermal roll of the present invention. In the production of the linerless thermal roll of the present invention, a web or substrate 10 coated with the thermosensitive layer 30 is fed through the production process in the direction of the arrow A to conventional coaters 80, 84 and a printer 82. The conventional coaters 80 and 84 are oriented in such a way that the adhesive coater 80 faces the web surface (first face) and the release material coater 84 faces the thermosensitive layer 30 (second face). The adhesive coater 80 applies a pressure sensitive adhesive (PSA) layer 20 on one side of the web or substrate 10. The PSA can be applied as a holt melt which coats one face of the substrate. To other side or face of the web or substrate 10 comprising the thermosensitive layer 30 is located a coater 84 for coating the thermosensitive layer 30 with a release material 50. Upstream of the release material coater 84 is a printer 82 for depositing at least one colour image 40 on the thermosensitive layer 30 prior to depositing the release layer. In order to print the at least one colour image 40 to the first portion of the thermosensitive layer 30, any known printing technique may be used. This includes inkjet printing, pad printing etc. Typically, if the at least one colour image 40 comprises a small number of colours, e.g. five or less, then standard ink printing will be used whereby each colour is applied separately. In the case where the at least one colour image comprises a large number of colours, e.g. six or greater, then digital printing techniques may be employed.

Subsequent to printing the colour image 40, a coater 84 applies a coating 50 comprising release material 50 directly onto the thermosensitive layer 30 comprising the printed colour image 40 such that the colour image 40 is sandwiched between the thermosensitive layer 30 and the release coating 50. For example, the release coating can be based on the coating taught in the art, EP 0579430 (Moore Business Forms, Inc), e.g. comprising QUILON C from Dupont Chemical Company. Optionally, as shown in dashed lines, a barrier coater 83 can be additionally applied to the thermosensitive layer 30 prior to the application of the release coating to prevent the release material 50 from soaking into the web material. The laminated web 10 is fed into a dryer 86 whereupon the coating materials, in particular the adhesive are dried onto the substrate 10. The dryer 86 can comprises a UV source for curing the silicone release coating on the thermosensitive layer 30. After the drying stage, the laminated web is fed into a cutter 88 whereupon the laminated web is cut into individual rolls 70 of linerless thermal sheets. Optionally, the cutter 88 can also apply the machine readable demarcations 60 across the laminated web in a direction perpendicular to the movement of the web so as to provide a separation of the linerless thermal sheets into individual linerless labels. The apparatus shown in FIG. 4 is for illustration only and alternative embodiments are permissible in the present invention depending on the type of adhesive and/or release coating material used. For example, the dryer can be replaced by a UV source where the release coating is a UV curable silicone material. Equally, hot melt adhesives do not require drying equipment.

1. A linerless thermal sheet arranged as a roll, comprising:
a substrate having a first face and a second face, whereby the first face opposes the second face;
an adhesive layer on at least part of said first face of said substrate;
a thermosensitive layer on at least part of said second face of said substrate, said thermosensitive layer comprising a first portion and a second portion whereby the first portion is adjacent to the second portion such that the first portion and second portion do not overlap;
a release coating applied onto the thermosensitive layer, said release coating has a low adherence to said adhesive layer;
at least one colour image is deposited on the first portion of the thermosensitive layer so as to provide a blank window for thermally printed information in the second portion of the thermosensitive layer, whereby the at least one colour image is between the thermosensitive layer and the release coating.

2. The linerless thermal sheet of claim 1, wherein the blank window is for accommodating a barcode or a QR code.

3. The linerless thermal sheet of claim 1, further comprising a machine-readable demarcation indicating a tear/cut line.

4. The linerless thermal sheet of claim 1, wherein the at least one colour image is deposited by inkjet printing, offset printing, pad printing or roller printing.

5. The linerless thermal sheet of claim 1, wherein the at least one colour image is deposited on at least one margin of the thermosensitive layer.

6. The linerless thermal sheet of claim 1, wherein the thermosensitive layer is a colour-forming system.

7. The lineless thermal sheet of claim 6, wherein the colour-forming system is a leuco dye system.

8. The linerless thermal sheet of claim 1, wherein the machine-readable demarcation is any one of a cut-out notch, a perforation, the at least one colour image mark and/or the thermally-printed information.

9. The linerless thermal sheet of claim 1, wherein the thermally-printed information is at least one of a machine-readable representation of data, barcode, QR code, Unicode character(s), demarcation indicator(s) and/or image(s).

10. A method of manufacturing a linerless thermal sheet arranged as a roll comprising the steps:
(i) depositing a colour image to a first portion of a thermosensitive layer on a first face of a substrate that is arranged to provide a blank second portion of the thermosensitive layer on the first face;
(iii) apply a release coating on the thermosensitive layer on the first face of the substrate so as to sandwich the colour image between the thermosensitive layer and said release coating; and
(iv) applying an adhesive to a second face of the substrate, whereby the second face of the substrate opposes the first face of the substrate.

11. The method of claim 10, further comprising the step of providing at least one machine-readable demarcation to indicate a cut/tear line, said machine-readable demarcation being at least one of a cut-out, rear-printed black marks.

12. The method of claim 10, further comprising the step of applying thermally-printed information on the blank second portion of the thermosensitive layer.
